(19) United States
(12) Patent Application Publication
(10) Pub. No.: US 2006/0233160 A1
(43) Pub. Date: Oct. 19, 2006

(54) Call system, proxy dial server apparatus and proxy dial method for use therewith, and program thereof

(75) Inventors: Kazuhito Kawanishi, Tokyo (JP); Hiroshi Kurihara, Tokyo (JP); Hiromi Murakawa, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/402,714

(22) Filed: Apr. 12, 2006

(30) Foreign Application Priority Data
Apr. 13, 2005 (JP) 2005-115375

(51) Int. Cl. H04L 12/66

(52) U.S. Cl. 370/352

(57) ABSTRACT

The present invention is intended to provide a call system which can authenticate a call initiation request from a proxy dial server apparatus with a caller number specified by the proxy dial server apparatus without adding special processing. In the configuration according to the present invention, proxy dial server apparatus first requests telephone server apparatus to call a telephone number of a user. In this event, proxy dial server apparatus uses the telephone number of the user as a caller ID. Upon receipt of a call request, telephone server apparatus transmits an authentication challenge to proxy dial server apparatus for authenticating the caller ID. Upon receipt of the authentication challenge, proxy dial server apparatus generates a response using a user ID and a password previously registered in association with the user's telephone. This results in successful authentication by telephone server apparatus, allowing a call to terminate at the user's telephone number.

### BACKGROUND OF THE INVENTION

1. Field of the Invention

The present invention relates to a call system, a proxy dial server apparatus and a proxy dial method for use therewith, and a program thereof, and more particularly, to a proxy dial system for dialing a called terminal in place of a calling terminal.

2. Description of the Related Art

Conventionally, as disclosed in JP-A-2004-236158, a proxy dial system comprises HTTP (Hyper Text Transfer Protocol) server means connectable to the Internet, user authentication means, means for searching for a use's subscriber number from a user account, means for generating a command to a call controller in response to a destination entered from a terminal on the Internet through a predetermined operation, calling means for initiating a call in accordance with the command, and connection means for connecting a user's subscriber terminal to the destination.

This proxy dial system assumes an exchanger connected to a public network, but when the proxy dial system is applied to an existing IP (Internet Protocol) telephone system, a call initiated from the proxy dial system must be handled as a call from an associated subscriber in order that a variety of functions are also available when the proxy dial system is in use, such as a full-time non-display service provided by the existing IP telephone service. In this event, a mechanism is required for the proxy dial system to support authentication processing which is generally performed when a call is initiated from a subscriber in the IP telephone system.

In an ordinary point-to-point call, there is a calling party and a called party, and an identifier such as a telephone number for communicating a telephone of the calling party and information on the calling party to a carrier and the called party is authenticated by a network device of the carrier, and a call can be placed only when the initiation is permitted.

For example, in an IP telephone system using SIP (Session Initiation Protocol) (RFC3261), an IP telephone server authenticates a password using a standardized authentication mechanism (HTTP Digest authentication), identifies a calling party, and permits a call.

On the other hand, in a proxy dial system for implementing a point-to-point call from a third party, an application such as a web application, for example, specifies two parties, i.e., a calling party and a called party, to establish a connection between the two parties. Therefore, the proxy dial system can be jeopardized by a third party, a perfect stranger, who spoofs a calling party to establish a connection between two parties irrespective of the wishes of the calling party.

For avoiding this possibility, a conventional proxy dial system must identify a third party via a mechanism different from the network device of a carrier, and confirm whether or not the third party is allowed to perform a calling operation in place of a calling party through authentication processing such as a query made to the network device of the carrier, and the like.

3. Summary of the Invention

Therefore, to solve the problem mentioned above, it is an object of the present invention to provide a call system which is capable of authenticating a call request from a proxy dial server apparatus with a caller number specified by the proxy dial server apparatus without adding special processing, the proxy dial server apparatus, and a proxy dial method for use therewith, as well as a program thereof.

A call system according to the present invention has a proxy dial server apparatus which acts as a substitute to perform a call initiation operation involved in making a point-to-point call between a calling terminal and a called terminal based on control of a telephone server apparatus, wherein:

the proxy dial server apparatus comprises means for transmitting to the telephone server apparatus a request for calling the calling terminal and a request for calling the called terminal based on information on the calling party, and means for creating authentication data for an authentication request from the telephone server apparatus in response to the call request based on the information on the calling party, and transmitting the information to the telephone server apparatus.

A proxy dial server apparatus according to the present invention acts as a substitute for performing a call initiation operation involved in making a point-to-point call between a calling terminal and a called terminal based on control of a telephone server apparatus. The proxy dial server apparatus comprises:

means for transmitting to the telephone server apparatus a request for calling the calling terminal and a request for calling the called terminal based on information on a calling party, and means for creating authentication data for an authentication request from the telephone server apparatus in response to the call request based on information on the calling party, and transmitting the information to the telephone server apparatus.

A proxy dial method according to the present invention is for use by a call system which has a proxy dial server apparatus that act as a substitute for performing a call initiation operation involved in making a point-to-point call between a calling terminal and a called terminal based on control of a telephone server apparatus, wherein:

the proxy dial server apparatus executes processing for transmitting to the telephone server apparatus a request for calling the calling terminal and a request for calling the called terminal based on information on a calling party, and processing for creating authentication data for an authentication request from the telephone server apparatus in response to the call request based on information on the calling party, and transmitting the information to the telephone server apparatus.

A program for implementing a proxy dial method according to the present invention is for use by a call system which has a proxy dial server apparatus that act as a substitute for performing a call initiation operation involved in making a point-to-point call between a calling terminal and a called terminal based on control of a telephone server apparatus, wherein the program causes a computer of the proxy dial server apparatus to execute processing for transmitting to the telephone server apparatus a request for calling the calling terminal and a request for calling the called terminal based on information on a calling party, and processing for creating authentication data for an authentication request from the telephone server apparatus in response to the call request based on information on the calling party, and transmitting the information to the telephone server apparatus.

Specifically, the call system of the present invention provides means for authenticating whether or not a third party is permitted to perform a call initiation operation in place of a caller when a point-to-point call is connected from the third party.

In the call system of the present invention, a user ID and a password, utilized for authentication by a network device, are used when a call is placed between a calling party and a called party which are specified by a third party, so that the authentication can be commonly carried out for the third party and for the identifier such as a telephone number for conveying information about the telephone of the calling party and information about the calling party to a carrier and to the called party upon call initiation.

Accordingly, in the call system of the present invention, the telephone server apparatus can authenticate a call initiation request from the proxy dial server apparatus with a caller number specified by the proxy dial server apparatus without adding special processing to the telephone server apparatus by utilizing the authentication processing upon call initiation from an ordinary terminal.

With the foregoing advantage, in the call system of the present system, even if a proxy dial server apparatus is added, the call initiation processing itself from the proxy dial server apparatus can be managed in accordance with an authentication policy which is set by the telephone server apparatus.

Also, in the call system of the present invention, the telephone server apparatus handles a call initiated from the proxy dial server apparatus in a manner similar to a call initiated from an ordinary terminal, so that even for a call initiated from the proxy dial server apparatus, the telephone server apparatus permits the activation of service for a caller number specified by the proxy dial server apparatus, without adding special processing to the telephone server apparatus, so that services generally utilized by a caller can be utilized even through the proxy dial server apparatus.

With the foregoing advantages, the call system of the present invention can permit the utilization of services provided by the telephone server apparatus for a calling party, such as control of caller number display/non-display and the like, such that the caller can utilize such services even if the caller requests call initiation from a web browser or when the caller registers call initiation time in a time-activated call initiation program.

With the configuration and operations as described below, the present invention advantageously allows a call initiation request from the proxy dial server apparatus to be authenticated with a caller number specified by the proxy dial server apparatus without adding special processing.

### BRIEF DESCRIPTION OF THE DRAWINGS

FIG. 1 is a block diagram illustrating the configuration of a call system according to one embodiment of the present invention;

FIG. 2 is a block diagram illustrating the configuration of a proxy dial server apparatus according to one exemplary implementation of the present invention;

FIG. 3 is a sequence chart showing operations for establishing a connection between terminals in the call system according to one exemplary implementation of the present invention;

FIG. 4a and FIG. 4b is a flow chart illustrating operation of the proxy dial server apparatus in FIG. 2; and

FIG. 5 is a block diagram illustrating the configuration of a call system according to another exemplary implementation of the present invention;

### DETAILED DESCRIPTION OF THE PREFERRED EMBODIMENTS

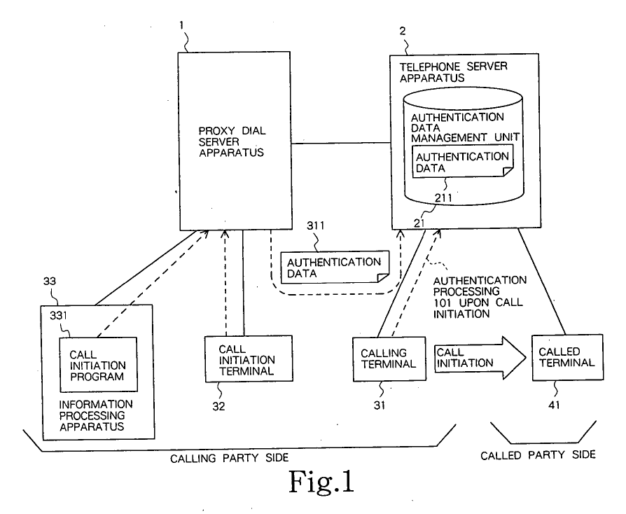

Next, embodiments of the present invention will be described with reference to the drawings. FIG. 1 is a block diagram illustrating the configuration of a call system according to one embodiment of the present invention. In FIG. 1, the call system according to this embodiment of the present invention comprises proxy dial server apparatus 1, telephone server apparatus 2, calling terminal 31 of a calling party, call initiation terminal 32, information processing apparatus 33 in which call initiation program 331 is installed, and called terminal 41 of the called party.

A user of calling terminal 31 activates a web browser from a web client of a PC: personal computer (call initiation terminal 32 or information processing apparatus 33) to access a web server (not shown). The web server authenticates the user, and permits the user to make access when the user is successfully authenticated. The user clicks on the telephone number of a called party, to which the user wishes to place a call, on a web screen, to make a request for connection by the clicked number.

In response to the clicking of the user, the web server notifies proxy dial server apparatus 1 of the clicked telephone number to make a request for connection and the telephone number of the user which is identified as the result of the user authentication and has previously been registered.

Proxy dial server apparatus 1 first requests telephone server apparatus 2 to call the telephone number of the user. In this event, proxy dial server apparatus 1 uses the users telephone number as a caller ID.

Upon receipt of the call request, telephone server apparatus 2 transmits an authentication challenge to proxy dial server apparatus 1 for authenticating the caller ID. Upon receipt of the authentication challenge, proxy dial server apparatus 1 generates a response using a user ID and a password previously registered in association with the user's telephone number, thereby resulting in successful authentication by telephone server apparatus 1 to allow a call to terminate at the user's telephone number.

In this event, the used user ID and password may be managed and notified to proxy dial server apparatus 1 by the web server, like the user's telephone number, or the user's telephone number, user ID, and password may be all entered by the user. It is also contemplated that the user ID and password are common to the user ID and a password used by the web server for user authentication.

For terminating a call to the clicked telephone number, proxy dial server apparatus 1 makes a request to telephone server apparatus 2 using the user's telephone number as caller ID in a manner similar to the operation involved in the call initiated from the user. Upon receipt of the call request, telephone server apparatus 2 transmits an authentication challenge to proxy dial server apparatus 1 for authenticating the caller ID. Upon receipt of the authentication challenge, proxy dial server apparatus 1 generates a response using the user name and password previously registered in association with the user's telephone number, thereby resulting in successful authentication by telephone server apparatus 2 to allow a call to terminate at the clicked telephone number.

Here, user authentication processing in the web server, and processing for connecting terminals, which have been called in proxy dial server apparatus 1, are not directly related to the present invention, so that a description thereon is omitted.

### Exemplary Implementation 1

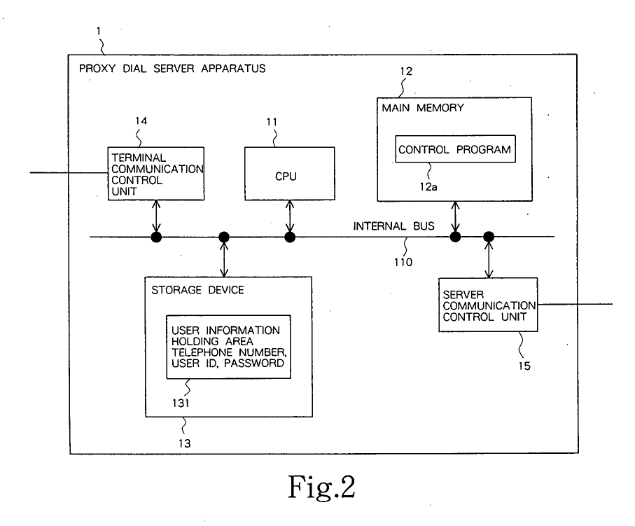

Next, one exemplary implementation of the present invention will be described with reference to the drawings. FIG. 2 is a block diagram illustrating the configuration of a proxy dial server apparatus according to one exemplary implementation of the present invention. It should be noted that a call system according to this exemplary implementation of the present invention is similar in configuration to the call system according to the embodiment of the present invention illustrated in FIG. 1, and the proxy dial server apparatus according to the this exemplary implementation of the present invention corresponds to proxy dial server apparatus 1 in FIG. 1.

In FIG. 2, proxy dial server apparatus 1 comprises CPU (central processing unit) 11 for controlling the overall apparatus and executing a variety of processing; main memory 12 for storing control program 12a executed by CPU 11; storage device 13 which has user information holding area 131 for holding information on users (telephone number, user ID, password and the like); terminal communication control unit 14 for controlling communications between proxy dial server apparatus 1 and the terminal of a calling party; and server communication control unit 15 for controlling communications between proxy dial server apparatus 1 and telephone server apparatus 2 and the aforementioned web server. CPU 11, main memory 12, storage device 13, terminal communication control unit 14, and server communication control unit 15 are interconnected through internal bus 110.

Telephone server apparatus 2 is a computer which operates under control of programs, while proxy dial server apparatus 1 receives a request from call initiation terminal 32 or call initiation program 331 other than calling terminal 31 to act as substitute for a calling party to perform operations for placing a call from calling terminal 31 to called terminal 41.

Here, telephone server apparatus 2 manages information for identifying terminals such as IP addresses of calling terminal 31 and called terminal 41, and an identifier such as a telephone number for communicating information on a calling party to a called party, and includes a function for connecting the two parties when a call is initiated from calling terminal 31 to called terminal 41.

Also, telephone server apparatus 2 holds authentication data 211 such as a user name, a password and the like in authentication data management unit 21 for identifying a calling party who is utilizing calling terminal 31, and comprises a function of authenticating the calling party based on authentication data 211 when a call is initiated from calling terminal 31.

In an ordinary call placed from calling terminal 31 to called terminal 41 using telephone server apparatus 2, calling terminal 31 transmits authentication data 311 such as the user name, password and the like previously other than an identifier such as a telephone number for specifying called terminal 41 managed by calling terminal 31 to telephone server apparatus 2. Then, telephone server apparatus 2 compares authentication data 211 such as the user name, password and the like managed by telephone authentication data management unit 21 with authentication data 311 transmitted from calling terminal 31 to authenticate calling terminal 31 and permit a call directed to called terminal 41.

The foregoing authentication and permission thus performed ensure that a call directed to called terminal 41 is initiated from calling terminal 31, so that telephone server apparatus 2 can transmit the identifier of calling terminal 31, such as the telephone number, to called terminal 41, and notify called terminal 41 of information on calling terminal 31, thus permitting a called party to recognize a call initiated from the calling party.

In the call system configured as described above, proxy dial server apparatus 1 in the present invention comprises a function of bringing a call initiated from calling terminal 31 to called terminal 41, after the authentication performed by telephone server apparatus 2 using authentication data 311 of the calling party, in response to a request from call initiation terminal 32 which is a device other than calling terminal 31 of the calling party, and makes a request that is transmitted by call initiation program 33.

For example, a request from call initiation terminal 32 is transmitted by a caller who clicks on information on a called party on a WWW browser viewed on the screen of the computer. A request from call initiation program 33 in turn automatically transmits information on a previously specified called party when a certain time is reached.

A mechanism for placing a call from calling terminal 31 to called terminal 41 through proxy dial server apparatus 1 is implemented in such a manner that proxy dial server apparatus 1 calls both calling terminal 31 and called terminal 41, and connects both terminals to each other when both terminals are available for a call. The two terminals may be connected by any method which is not directly related to the present invention, so that a description on associated operations is omitted.

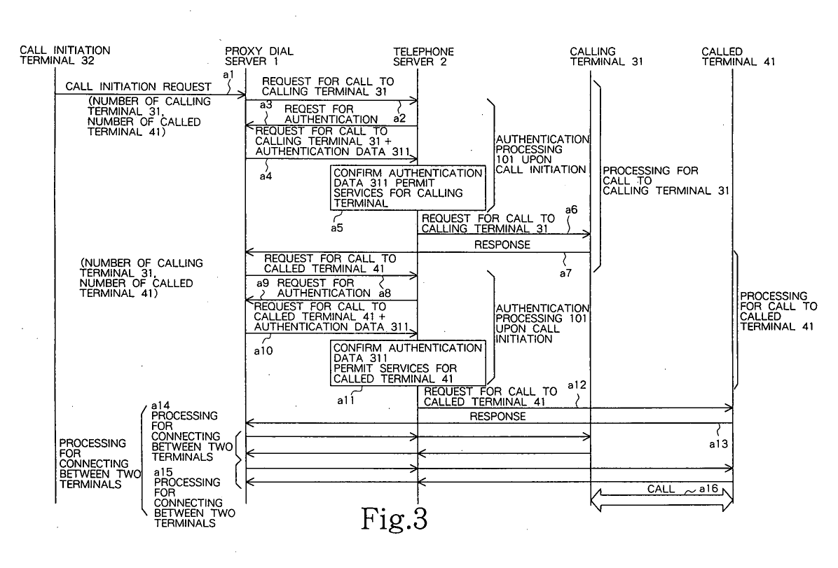

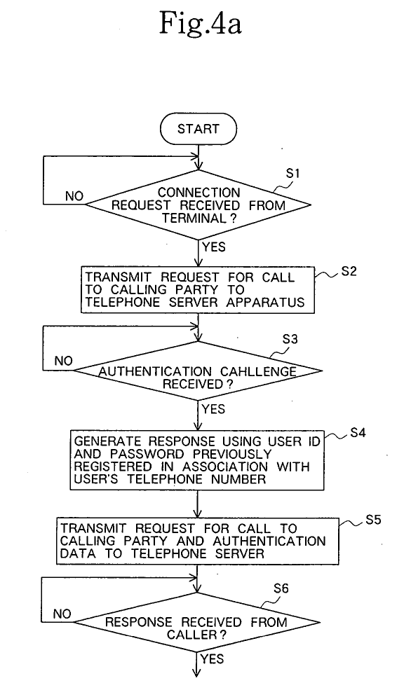

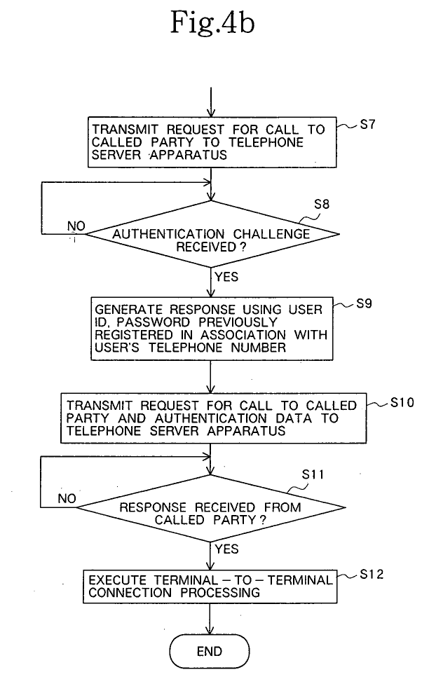

FIG. 3 is a sequence chart illustrating operations for establishing a connection between terminals in the communication system according to one exemplary implementation of the present invention, and FIG. 4 is a flow chart illustrating the operation of proxy dial server apparatus 1 in FIG. 2. Referring to these FIGS. 1-4, a description will now be given of the operations for establishing a connection between terminals in the call system according to one exemplary implementation of the present invention. The processing illustrated in FIG. 4 is performed by CPU 11 of proxy dial server apparatus 1 which executes control program 12a.

First, upon receipt of a request for a call from calling terminal 31 to called terminal 41 made from call initiation terminal 32 or call initiation program 33 (a1 in FIG. 3 and step S1 in FIG. 4a), proxy dial server apparatus 1 performs authentication processing 101 (a2-a5 in FIG. 3 and steps S2-S5 in FIG. 4a), in order to authenticate that this is a call initiated from the calling party, in a manner similar to a call initiated from calling terminal 31.

Specifically, upon receipt of an authentication challenge from telephone server apparatus 2 (a3 in FIG. 3 and step S3 in FIG. 4a) after transmitting a request for a call to calling terminal 31 to telephone server apparatus 2 (a2 in FIG. 3 and step S2 in FIG. 4a), proxy dial server apparatus 1 transmits completely the same authentication data as authentication data 311 such as a user name, password and the like previously managed by calling terminal 31 (authentication data created on the basis of information held in user information holding area 131) to telephone server apparatus 2 (a4 in FIG. 3 and steps S4, S5 in FIG. 4a).

In the foregoing operation, proxy dial server apparatus 1 is treated as calling terminal 31 in telephone server apparatus 2 at this time. In this event, when a response returns from calling terminal 31 in response to the call request from telephone server apparatus 2 to calling terminal 31 (a6 in FIG. 3 and step S6 in FIG. 4b), proxy dial server apparatus 1 terminates the processing for a call to calling terminal 31.

Next, proxy dial server apparatus 1 again transmits completely the same authentication data such as the user name, password and the like previously managed in calling terminal 31 to telephone server apparatus 2 (a8-a9 in FIG. 3 and steps S7-S10 in FIG. 4b) when it places a call to called terminal 41. The user name, password and the like may be entered by the calling party at call initiation terminal 32, or these may be information previously set by the calling party through call initiation program 33.

In the foregoing operation, proxy dial server apparatus 1 is treated as calling terminal 31 in telephone server apparatus 2 at this time. In this event, when a response returns from called terminal 41 in response to the call request from telephone server apparatus 2 to called terminal 41 (a13 in FIG. 3 and step S11 in FIG. 4b), proxy dial server apparatus 1 terminates the processing for a call to calling terminal 41.

At the time calling terminal 31 and called terminal 41 are both available for a call, proxy dial server apparatus 1 performs processing for connecting the two terminals to each other (a14, a15 in FIG. 3 and step S12 in FIG. 4), thus enabling a call to be made between calling terminal 31 and called terminal 41 (a16 in FIG. 3).

Thus, in this exemplary implementation, since proxy dial server apparatus 1 performs authentication processing 101 upon call initiation in a manner similar to a call initiated from calling terminal 31, telephone server apparatus 2 can ensure that a call initiation operation performed by proxy dial server apparatus 1 from calling terminal 31 to called terminal 41 has been requested by the calling party, without the need to provide telephone server apparatus 2 with special authentication/permission processing.

Also, in this exemplary implementation, since a call initiated from proxy dial server apparatus 1 to called terminal 41 is regarded as a call initiated from calling terminal 31, telephone server apparatus 2 can provide calling terminal 31 with those services conventionally provided thereby, such as caller number display, connection limitation, and the like.

### Exemplary Implementation 2

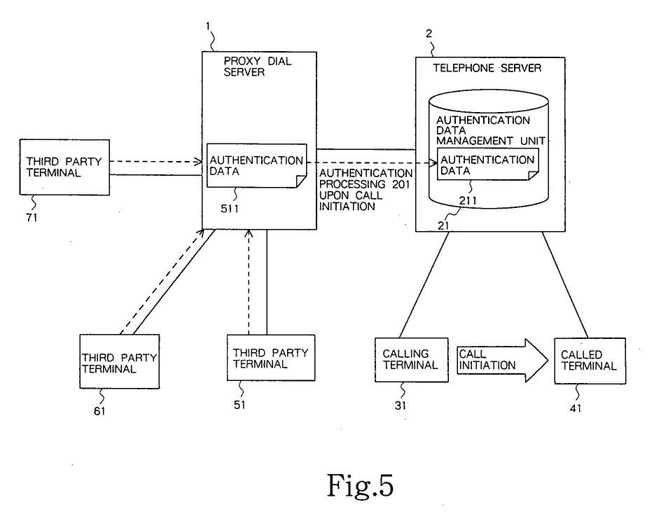

Next, another exemplary implementation of the present invention will be described with reference to the drawings. FIG. 5 is a block diagram illustrating the configuration of a call system according to another exemplary implementation of the present invention. In FIG. 5, the call system according to the other exemplary implementation of the present invention is similar in configuration to the communication system according to the embodiment of the present invention illustrated in FIG. 1 except that proxy dial server apparatus 1 manages authentication data 511 such as a user name, a password and the like of third parties other than calling terminal 31 and called terminal 41 which actually make a call therebetween, and registers authentication data 511 in telephone server apparatus 2 as data on third party terminals 51, 61, 71, where the same components are designated the same reference numerals.

Proxy dial server apparatus 1 manages authentication data 511 such as the user name, password and the like of third parties other than calling terminal 31 and called terminal 41 which actually make a call therebetween, and registers authentication data 511 in telephone server apparatus 2 as data on third party terminals 51, 61, 71, whereby third party terminals 51, 61, 71 can be handled in a manner equal to a single terminal, when viewed from telephone server apparatus 2. Stated another way, in this configuration, proxy dial server apparatus 1 treated as one terminal, and is called as if it were called from third party terminal 51, 61, 71 in actual call processing to calling terminal 31 and called terminal 41. Proxy dial server apparatus 1 authenticates users of third party terminals 51, 61, 71 to permit the start of services through a separate mechanism, thus enabling an indefinite number of users to establish a connection between calling terminal 31 and called terminal 41. In other words, in this exemplary implementation, proxy dial server apparatus 1 acts as a proxy for third parties and is responsible for call initiation processing.

The present invention can be applied to applications such as the realization of a one-click based call connection function using the telephone directory of a web system just by adding the aforementioned system to an existing IP telephone system without modifying functions of the IP telephone system.

What is claimed is:

1. A call system having a proxy dial server apparatus which acts as a substitute to perform a call initiation operation involved in making a point-to-point call between a calling terminal and a called terminal based on control of a telephone server apparatus, wherein:
said proxy dial server apparatus comprises:
means for transmitting to said telephone server apparatus a request for calling said calling terminal and a request for calling said called terminal based on information on a calling party; and
means for creating authentication data for an authentication request from said telephone server apparatus in response to the call request based on the information about the calling party, and transmitting the information to said telephone server apparatus.

2. The call system according to claim 1, wherein said information about the calling party includes at least user identification information and a password of the calling party which are utilized in authentication processing of a network device.

3. The call system according to claim 1, wherein said telephone server apparatus handles a call initiated from said proxy dial server apparatus in a manner similar to a call from an ordinary terminal.

4. The call system according to claim 1, wherein said proxy dial server apparatus transmits the call request and the authentication data to said telephone server apparatus when a request for a connection to said called terminal is entered by means other than said calling terminal.

5. The call system according to claim 4, wherein said means other than said calling terminal includes at least means for instructing call initiation from browser software and means for executing a time-triggered call initiation program which is includes a call initiation time.

6. A proxy dial server apparatus for acting as a substitute to perform a call initiation operation involved in making a point-to-point call between a calling terminal and a called terminal based on control of a telephone server apparatus, said proxy dial server apparatus comprising:
means for transmitting to said telephone server apparatus a request for calling said calling terminal and a request for calling said called terminal based on information on a calling party; and
means for creating authentication data for an authentication request from said telephone server apparatus in response to the call request based on the information on the calling party, and transmitting the information to said telephone server apparatus.

7. The proxy dial server apparatus to claim 6, wherein said information on the calling party includes at least user identification information and a password of the calling party which are utilized in authentication processing of a network device.

8. The proxy dial server apparatus according to claim 6, wherein said telephone server apparatus handles a call initiated from said proxy dial server apparatus in a manner similar to a call from an ordinary terminal.

9. The proxy dial server apparatus according to claim 6, wherein said proxy dial server apparatus transmits the call request and the authentication data to said telephone server apparatus when a request for a connection to said called terminal is entered by means other than said calling terminal.

10. The proxy dial server apparatus according to claim 9, wherein said means other than said calling terminal includes at least means for instructing call initiation from browser software and means for executing a time-triggered call initiation program which is includes a call initiation time.

11. A proxy dial method for use by a call system which has a proxy dial server apparatus for acting as a substitute to perform a call initiation operation involved in making a point-to-point call between a calling terminal and a called terminal based on control of a telephone server apparatus, wherein:
said proxy dial server apparatus executes:
processing for transmitting to said telephone server apparatus a request for calling said calling terminal and a request for calling said called terminal based on information on a calling party; and
processing for creating authentication data for an authentication request from said telephone server apparatus in response to the call request based on the information on the calling party, and transmitting the information to said telephone server apparatus.

12. The proxy dial method according to claim 11, wherein said information on the calling party includes at least user identification information and a password of the calling party which are utilized in authentication processing of a network device.

13. The proxy dial method according to claim 11, wherein said telephone server apparatus handles a call initiated from said proxy dial server apparatus in a manner similar to a call from an ordinary terminal.

14. The proxy dial method according to claim 11, wherein said proxy dial server apparatus transmits the call request and the authentication data to said telephone server apparatus when a request for a connection to said called terminal is entered by means other than said calling terminal.

15. The proxy dial method according to claim 14, wherein said means other than said calling terminal includes at least means for instructing call initiation from browser software and means for executing a time-triggered call initiation program which is registered with a call initiation time.

16. A program for implementing a proxy dial method for use by a call system which has a proxy dial server apparatus for acting as a substitute to perform a call initiation operation involved in making a point-to-point call between a calling terminal and a called terminal based on control of a telephone server apparatus, wherein:
said program causes a computer of said proxy dial server apparatus to execute:
processing for transmitting to said telephone server apparatus a request for calling said calling terminal and a request for calling said called terminal based on information on a calling party; and
processing for creating authentication data for an authentication request from said telephone server apparatus in response to the call request based on the information on the calling party, and transmitting the information to said telephone server apparatus.
